(19) United States
(12) Patent Application Publication
(10) Pub. No.: US 2009/0234692 A1
(43) Pub. Date: Sep. 17, 2009

(54) Method and System for Configuring Solar Energy Systems

(75) Inventors: Earl G. Powell, Sunnyvale, CA (US); Maxym Makhota, Cupertino, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Tigo Energy, Inc., Los Gatos, CA (US)

(21) Appl. No.: 12/357,357

(22) Filed: Jan. 21, 2009

Related U.S. Application Data
(60) Provisional application No. 61/069,279, filed on Mar. 13, 2008.

(51) Int. Cl. G06Q 10/00; G06F 17/50; G06F 7/06; G06F 17/30; G06F 3/048; G06Q 50/00

(52) U.S. Cl. 705/7; 703/1; 707/3; 707/5; 715/760; 707/E17.019; 707/E17.018; 707/E17.016

(57) ABSTRACT

A system and method of configuring solar energy systems that includes at least one processor, and a memory coupled to the at least one processor. The memory can store instructions to cause the at least one processor to 1) search one or more data sources for information, 2) store the information in a data store, 3) receive one or more images associated with a location to receive a solar energy system, 4) display the one or more images in real-time on a user interface on a display, 5) receive input data from a user interacting with the user interface, 6) process the information, images, and input data to determine parameters associated with the location, and 7) identify a useable area in the location for placement of the solar energy system based on the parameters.

### CROSS-REFERENCE TO RELATED APPLICATIONS

This application claims priority to U.S. Provisional Patent Application Ser. No. 61/069,279, filed Mar. 13, 2008, the entirety of which is incorporated herein by reference.

### FIELD OF THE INVENTION

The present invention relates generally to solar energy systems, and more particularly, to systems and methods for configuring solar energy systems.

### BACKGROUND

The installation of a solar energy generation system, such as a solar photovoltaic and/or solar thermal generation system, can be a complex endeavor that may require analyzing several issues to determine the effectiveness and profitability of a proposed installation. Planners must be able to quickly and accurately calculate costs, and determine an appropriate size system for a particular location.

To accomplish this task, planners must evaluate technical issues and environmental issues. The technical issues may include determining the ideal method of mounting a solar energy system at a particular location, or determining the relative energy that can be obtained from the system. Environmental issues may include determining whether the climate of a particular region or location is conducive to the installation of a solar energy system. Business environment issues may include determining if any local, state, and federal government incentives, tax credits, or subsidies are applicable.

It can be an arduous task to manually collect and assess all the necessary information, and then utilize the information to configure and determine the profitability of a proposed solar energy system installation.

Accordingly, there is a need for improved systems and methods for configuring solar energy systems.

### SUMMARY OF THE INVENTION

In one aspect, the invention features a system for configuring solar energy systems. The system can include at least one processor, and a memory coupled to the at least one processor. The memory can store instructions to cause the at least one processor to 1) search one or more data sources for information, 2) store the information in a data store, 3) receive one or more images associated with a location to receive a solar energy system, 4) display the one or more images in real-time on a user interface on a display, 5) receive input data from a user interacting with the user interface, 6) process the information, images, and input data to determine parameters associated with the location, and 7) identify a useable area in the location for placement of the solar energy system based on the parameters.

One or more of the following features may also be included. The processor can overlay the input data on the displayed image. The processor can determine position of the solar energy system within the useable area based on angle and east-west orientation of the useable area. The processor can generate a graphical representation of the solar energy system in the useable area of the location, and can display the graphical representation on the user interface in real-time. The processor can generate and present on the display at least one of a bill of materials or price quote for the solar energy system. The processor can receive from the user a selection of the solar energy system for purchase. The processor may utilize an application programming interface (API) and/or a screen scraper to search the one or more data sources for the information. The data sources can include at least one of websites and databases. The information may include product data, services, incentives, rate structures, and regulations pertaining to solar energy systems. The processor can receive the one or more images in real-time from remote servers. The processor can receive the one or more images from the data store. The images can be map images, terrain images, and topology images. The location can be a roof of a building. The processor can display the one or more images in real-time on the user interface in response to a request by the user for the one or more images. The request by the user can include an address or latitude and longitude coordinates of the location, or both. The user interface can be a web browser. The display can be on any handheld communication device, laptop, and desktop computer. The input data may include points, lines, geometric shapes, height measures, and length measures associated with the displayed one or more images. The input data can identify particular points, lines, and geometric shapes in each of the displayed images. The parameters can include location area, three-dimensional coordinates, latitude, longitude, azimuth angle, orientation, alignment, pitch, ambient temperature of the location, indications of shading obstructions in the useable area, and size of the solar energy system that can fit in the useable area. The graphical representation can be two-dimensional. The graphical representation can be three-dimensional.

In another aspect, the invention features a method of configuring solar energy systems. The method can include 1) searching one or more data sources for information, 2) storing the information in a data store, 3) receiving one or more images associated with a location to receive a solar energy system, 4) displaying the one or more images in real-time on a user interface on a display, 5) receiving input data from a user interacting with the user interface, 6) processing the information, images, and input data to determine parameters associated with the location, and 7) identifying a useable area in the location for placement of the solar energy system based on the parameters.

One or more of the following features may also be included. Overlaying the input data on the displayed image. Determining position of the solar energy system within the useable area based on angle and east-west orientation of the useable area. Generating a graphical representation of the solar energy system in the useable area of the location, and displaying the graphical representation on the user interface in real-time. Displaying at least one of a bill of materials or price quote for the solar energy system. Receiving from the user, a selection of the solar energy system for purchase. Receiving the one or more images can include requesting the one or more images in real-time from remote servers. Receiving the one or more images can include retrieving the one or more images from the data store. Displaying the one or more images in real-time can be in response to a request by the user. Processing can include identifying identical points, lines, or geometric shapes in each of the displayed images.

In another aspect, the invention features a computer readable medium having stored therein program instructions that are executable to perform 1) searching one or more data sources for information, 2) storing the information in a data store, 3) receiving one or more images associated with a location to receive a solar energy system, 4) displaying the one or more images in real-time on a user interface on a display, 5) receiving input data from a user interacting with the user interface, 6) processing the information, images, and input data to determine parameters associated with the location, and 7) identifying a useable area in the location for placement of the solar energy system based on the parameters.

One or more of the following features may also be included. Program instructions for overlaying the input data on the displayed image. Program instructions for determining position of the solar energy system within the useable area based on angle and east-west orientation of the useable area. Program instructions for generating a graphical representation of the solar energy system in the useable area of the location, and displaying the graphical representation on the user interface in real-time. Program instructions for displaying at least one of a bill of materials or price quote for the solar energy system. Program instructions for receiving from the user a selection of the solar energy system for purchase. Program instructions for requesting the one or more images in real-time from remote servers. Program instructions for retrieving the one or more images from the data store. Program instructions for displaying the one or more images in real-time in response to a request by the user. Program instructions for identifying identical points, lines, or geometric shapes in each of the displayed images.

Other features and advantages of the invention are apparent from the following description, and from the claims.

### BRIEF DESCRIPTION OF THE DRAWINGS

FIG. 1 illustrates a system architecture for use in accordance with one embodiment of the present invention.

FIG. 2 illustrates a top view of a component for use in connection with the present invention.

FIG. 3 illustrates a South facing view of a component for use in connection with the present invention.

FIG. 4 illustrates a East facing view of a component for use in connection with the present invention.

FIG. 5 illustrates a North facing view of a component for use in connection with the present invention.

FIG. 6 illustrates a West facing view of a component for use in connection with the present invention.

FIG. 7 illustrates an exemplary image of a location for use in connection with the present invention.

FIG. 8 illustrates an exemplary view of available solar installation area in accordance with an embodiment of the present invention.

FIG. 9 illustrates a plurality of solar panels superimposed onto an image of a structure in accordance with an embodiment of the present invention.

FIG. 10 illustrates exemplary hardware for configuring an embodiment of the present invention.

FIG. 11 illustrates an exemplary configuration with associated data in accordance with an embodiment of the present invention.

Like reference numbers and designations in the various drawings indicate like elements.

### DETAILED DESCRIPTION OF SPECIFIC EMBODIMENTS

Generally, the present invention provides a system and method for quickly configuring solar energy systems, such as a solar photovoltaic and solar thermal generation systems, while reducing the required research effort on the part of a user. The present invention can collect and aggregate information pertaining to solar energy systems from various sources, interact with users, and process data in real-time to determine whether a particular location is suitable for installing a solar energy system. If the location is determined to be suitable, a useable area within the location can be identified that is optimal for placement of a solar energy system. The configured energy systems can be displayed to users for purchase in real-time, along with a bill of materials and price quote. Costs and profitability can also be calculated for each configured solar energy system.

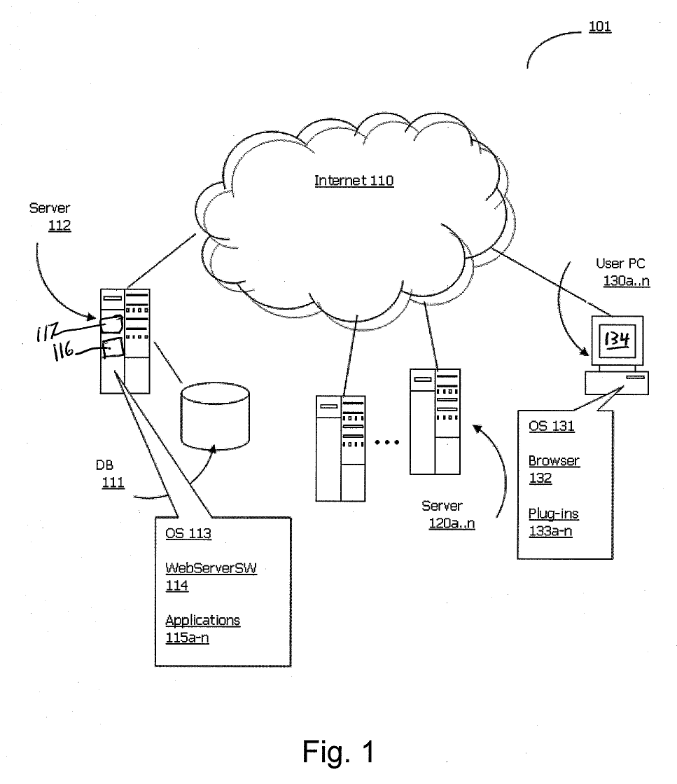

Referring to FIG. 1, exemplary system 101 can be utilized to configure solar energy systems in accordance with one embodiment of the present invention. System 101 can include a digital data processor, such as server 112, in communication with one or more data sources (such as remote servers 120), and user platforms 130 via a computer or communications network 110. The network 110 can be a LAN, MAN, WAN, the Internet, wireless network, telephone system, cable system or similar data transmission system. Communication through the network 110 may be accomplished wirelessly or through wired lines.

User platform 130 can be a desktop computer, laptop, cell phone, or any handheld communication device. In various embodiments, user platform 130 can include an operating system 131, a web browser 132, a display 134, and one or more plug-ins 133 that can be utilized to interact with various applications or servers. In an embodiment, web browser 132 or other graphical user interface (e.g., wizard) can be utilized by a user to interact with server 112. For example, web browser 132 may be utilized to provide input data or preferences to server 112. Browser 132 may also be utilized by a user to select displayed solar energy systems for purchase.

Servers 120 may be remotely located, and may be owned and operated by various third-party providers of data and applications, such as, a mapping service that can provide map, terrain, and topology images and photos, etc. In addition, one or more servers 120 may be owned and operated by domestic or foreign governments, and may host web pages or otherwise provide access to databases containing information pertaining to local, state, or federal government policies and incentives applicable to solar energy systems. For example, various incentives may be available if certain certifications and code compliance have been achieved. Various servers 120 may also provide information regarding restrictions on solar energy system installations, such as, city, state, and county regulations and codes.

Depending on the location of a proposed solar energy installation, a user may have the opportunity to take advantage of available incentives for purchasing solar energy panels. For example, Germany typically provides very large incentives for the purchase of solar energy equipment. On occasion, incentives for the purchase of solar equipment may also be provided in some areas by local power companies, such as, Pacific Gas & Electric and Sacramento Municipal Utility District in California, USA.

In various embodiments, server 112 can include an operating system 113, a web server 114, and other applications 115 that may be utilized to interact, for instance, with application program interfaces (APIs) of other applications operating on servers 120. Server 112 can also include an internal or external data store 111 for storing information pertaining to various solar energy systems. For example, the information can include material provided from servers 120, such as, product data, services, incentives, rate structures, tax credits, subsidies, and regulations pertaining to solar energy systems. In an embodiment, the data store 111 may also be populated with map, terrain, and topology images and photos of locations that may be candidate sites for receiving solar energy systems. For example, the locations may be rooftops of buildings and homes, or may be hillsides and fields, etc.

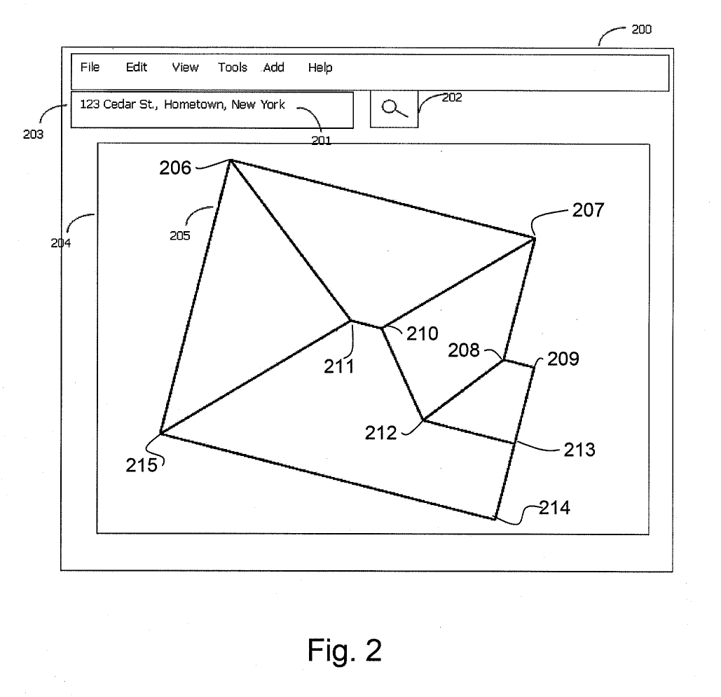

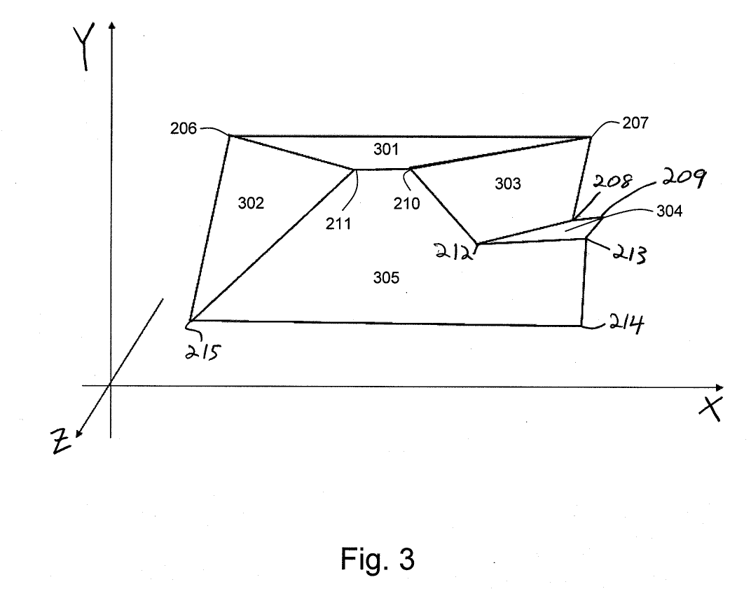

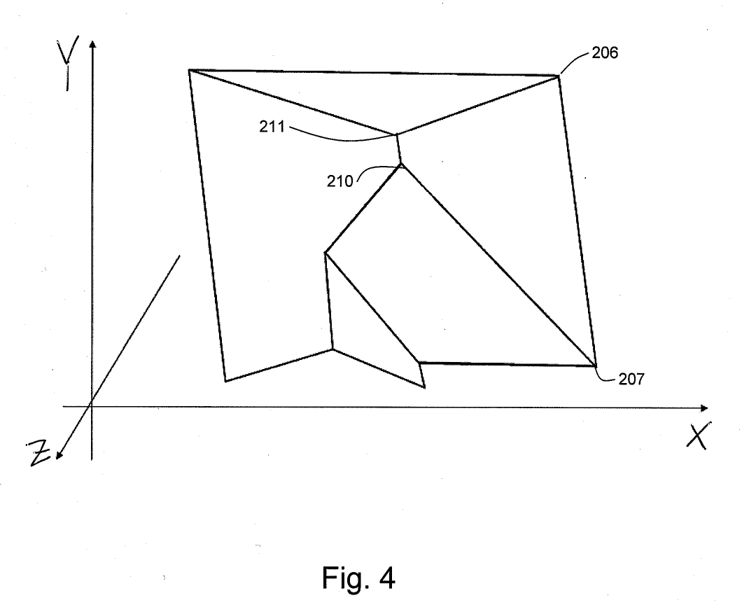

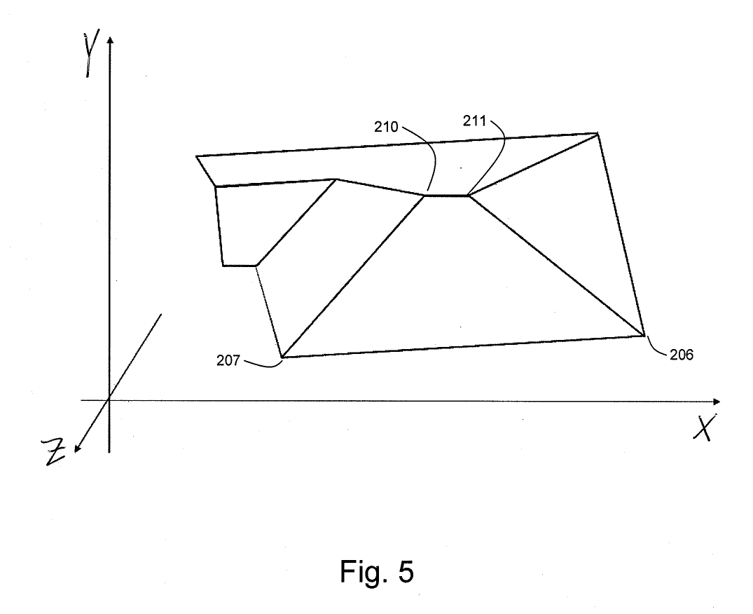

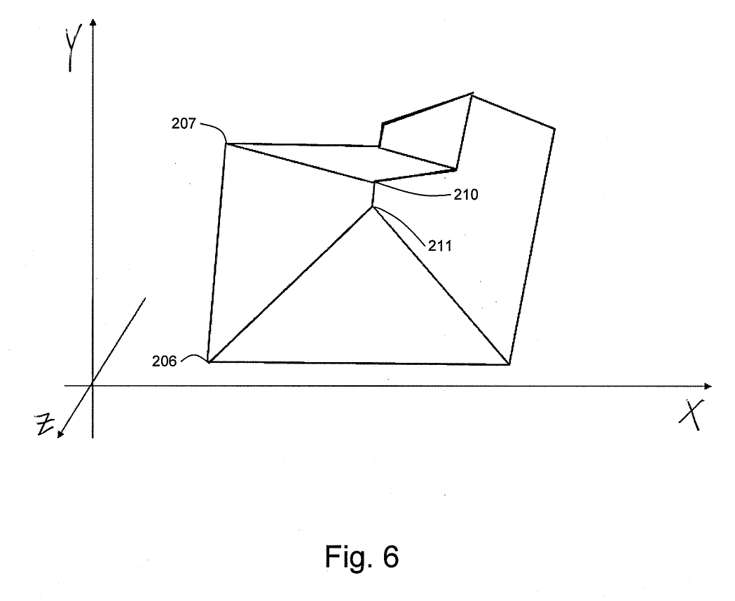

Referring to FIGS. 2-6, exemplary images of various perspective views of a rooftop 205 are illustrated. Specifically, FIG. 2 depicts an image of a top view of the rooftop 205. FIG. 3 depicts an image of a view of the rooftop 205 from the South. FIG. 4 depicts an image of a view of the rooftop 205 from the East. FIG. 5 depicts a view of the rooftop 205 from the North, and FIG. 6 depicts a view from the West. The images and photos can be collected in advance from a mapping service operating on servers 120, and can be stored in the data store 111 in various formats, for instance, bitmap, jpeg, gif, tiff, etc. In a preferred embodiment, rather than storing the images in data store 111, the images can be requested as needed in real-time from the servers 120.

Server 112 can further include at least one processor 117 that can control interactions and communications with servers 120, data store 111, user platforms 130, interact with users, and can coordinate runtime operations. In an embodiment, processor 117 can include a memory and an image processor 116 as an integral component or subsystem to provide an image recognition functionality.

In an embodiment, processor 117 can be configured to periodically search one or more data sources, such as websites and databases operating on servers 120, for information pertaining to solar energy systems. In particular, processor 117 can collect information that may include product information, services, rate structures, regulations, incentives, tax credits, and subsidies that may be applicable to solar energy systems. The processor 117 can utilize an application programming interface (API), screen scrapers, and web crawlers to facilitate the search and collection of relevant information from the displays, websites, and databases of the data sources.

Processor 117 can aggregate and store the collected information in data store 111, and can subsequently retrieve and utilize the information to determine, for instance, price quotes and profitability of installing particular solar energy systems.

Processor 117 can be configured to receive one or more images associated with a location (e.g., rooftop 205) slated to receive an installation of a solar energy system. Each of the images can be of the same location, but from a different view perspective. The images can be map images, terrain images, and topology images. Typically, in response to a request by the user for the one or more images, the processor 117 can request and receive the images in real-time from a mapping service operating on remote servers 120. Alternatively, if data store 111 is populated with the requested images, the processor 117 can retrieve the requested images from the data store 111.

Upon receiving the one or more images, processor 117 can transfer the images in real-time to user platform 130 for display on a user interface, such as web browser 132, on display 134. The user platform 130 can be a handheld communication device, laptop, or desktop computer. Typically, the processor 117 can display the one or more images in real-time on the user interface in response to a request by the user for the images. In an embodiment, the request by the user can include an address, or latitude and longitude coordinates of the location, or both.

Processor 117 can also be configured to receive input data from a user interacting with the web browser 132 or other user interface. The displayed images in web browser 132 can serve as a visual template to allow the user to interact with the processor 117 and provide additional information with which to evaluate the images. For example, the user can utilize the cursor or keyboard to draw or enter input data and provide it to the processor 117. The input data may include points, lines, geometric shapes, height measures, and length measures associated with the displayed images. The processor 117 can overlay the input data on the displayed image. The user can provide the input data to identify particular points, lines, and geometric shapes in each of the displayed images. For example, if a user provides a height of a rooftop and a height of the eaves of the rooftop as input data, the processor 117 can then calculate pitch of the rooftop.

Processor 117 can process the information, images, and input data to determine parameters associated with the particular location. The parameters can include location area, three-dimensional coordinates, latitude, longitude, azimuth angle, orientation, alignment, pitch, local climate indicators, ambient temperature of the location, presence of shading obstructions in the location area, and appropriate size of the solar energy system.

Obstructions can include shading from nearby trees and other structures. The locations and distances of trees or other structures can be recorded and compensated for. Typically, trees and shading on the south-east and south-west corners can be the most problematic. Trees on the south side may cast a shorter shadow than trees on the south-east or south-west sides. If a shading structure on the south side is far enough away from the solar energy system, little energy loss occurs. However, some types of solar panels may be subject to more shading-loss effects than others. For example, systems that use AC modules can be much less likely to experience overall system degradation from localized shading effects.

Latitude, local climate indicators, and ambient temperature of a slated location can be useful information to know when selecting solar panels or other components of a solar energy system. For example, some solar panels can be subject to large losses in efficiency if the panel's ambient temperatures are too high. For a site in Arizona, amorphous silicon thin film solar cells may be most appropriate, because they are less sensitive to temperature effects. However, in Wisconsin, where the ambient temperature can be lower, crystalline silicon wafers may be preferable. In addition to ambient, the ratio of diffuse to direct solar insolation can be considered as a relevant factor. In much of Europe and the United States the ratio of diffuse vs. direct solar insolation can be very high. In these locations an installation using amorphous silicon should be used, because of its ability to take advantage of both the direct and diffuse solar energy.

Referring to FIG. 3, the processor 117 can determine the parameters by first identifying surface planes 301-305, and ascertaining coordinates of connecting points 206-215 that define each surface plane. For example, surface plane 301 can be defined by connecting points 206, 207, 210, and 211. Surface plane 302 can be defined by connecting points 206, 215, and 211. Similarly, surface planes 303-305 can also be defined by their respective connecting points. The processor 117 can process each image having a different perspective view of the rooftop 205 shown in FIGS. 3-6 to determine all the surface planes and the respective surface plane connecting points. Processor 117 can then determine the three-dimensional coordinates of each of the connecting points 206-215. For example, connecting point 206 can be defined by coordinates X206, Y206, Z206. Connecting point 207 can be defined by coordinates X207, Y207, Z207, etc. The corresponding connecting points identified, by a user or by the processor 117, in the images are different two-dimensional projections of the same three-dimensional coordinates of the same point on the rooftop. Based on the projections on two or more planes (as recognized from at least two or more images), a set of projection equations can be used to solve for the three-dimensional coordinates or to determine a best fit for the three-dimensional coordinates. Once the coordinates of the connecting points are determined, the processor 117 can determine the size, area, and orientation of each surface plane 301-305. In addition, the size, area, and orientation of each surface plane 301-305 can be manually calculated from the coordinates of the connecting points.

In an embodiment, the present invention can provide for the placement of an image of a perspective view of the proposed site, so that a solar panel can be viewed in an optimal angle and orientation. The solar panel images can have a correct aspect ratio, and scale to be representative of recommended panels that may be available. This superimposition of the panels can also accommodate roof discontinuities, such as, chimneys and ventilation hardware. Various “what if” scenarios can be played out, for instance, to see if panel placement at a less than optimal angle and/or east-west orientation may be desired. Any losses, such as, the cosine θ (effectiveness of suboptimal angle θ) losses can be assessed and quantified.

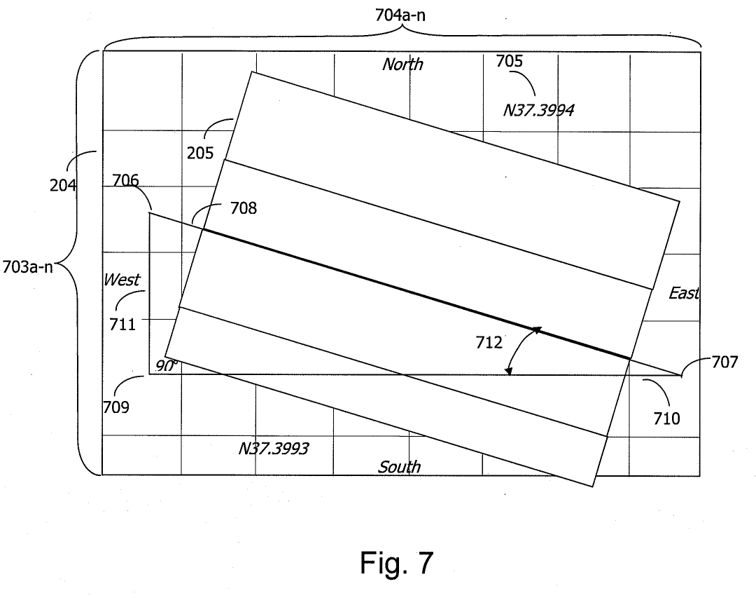

Referring to FIG. 7, processor 117 can determine latitude and east-west orientation of a ground location, or structure, such as rooftop 205, for potential placement of a solar energy system. Specifically, processor 117 can retrieve an image of a grid 204 from data store 111. Alternatively, the processor 117 can request grid 204 from servers 120. The grid 204 can include accurate depictions of latitude lines 703 and longitude lines 704. The grid 204 may also include the local latitude 705, which in this example is displayed as N37.3994°.

By knowing the latitude, a user can determine the optimum angle at which to place a solar energy system in relation to elevation. For example, for solar photovoltaic cells, an optimum angle can be the local latitude. For space heating, the optimal angle can be the local latitude plus 15°. For domestic hot water, the preferred angle may also be the local latitude.

In an embodiment, processor 117 can retrieve an image of rooftop 205, and can superimpose the image of rooftop 205 onto the image of grid 204 to determine the east-west orientation of rooftop 205. The processor 117 can transfer and present the superimposed image of grid 204 and rooftop 205, on web browser 132 on display 134 of user platform 130. A user, such as a solar installation analyst, may note from the presented image that rooftop 205 does not have a good east-west orientation.

Accordingly, the user may make a selection of an HTML link on the web browser 132 to initiate the processor 117 to calculate an offset angle from the true east-west axis. This calculation can also be accomplished manually by the user. In response, the processor 117 or the user can determine the offset angle, by drawing a series of lines to form a triangle with sides of known lengths. Initially, line 708 can be drawn on or parallel to the ridge of rooftop 205 (or some other feature that is representative of the long axis of rooftop 205). Another line can then be drawn from point 706 to point 709, which extends over line 708 and beyond the boundaries of rooftop 205. The processor 117 or user may also draw a line 710 that extends from point 707 to point 709. The processor 117 or user can then draw a final line 711 that is perpendicular to line 710, and extends from point 709 to point 706. The lengths of lines 708, 710, and 711 can then be calculated and recorded. The result is a triangle with known lengths of the sides. The known line lengths can then be utilized to calculate the angle offset from the true east-west axis as angle 712, which in this example is 15.9° to the west. Therefore, the placement of the solar energy system can be adjusted by 15.9° to the east, or the installation may be subject to 28% loss (cosign (15.9)). Thus the user may determine the latitude and the east-west orientation of the structure under consideration for receiving a solar energy system. The present invention provides several calculations and operations that can be performed automatically or semi-automatically by the processor 117, or manually by a user. Either way the available area of a roof or other feature can be calculated and evaluated for suitability to install a solar energy system.

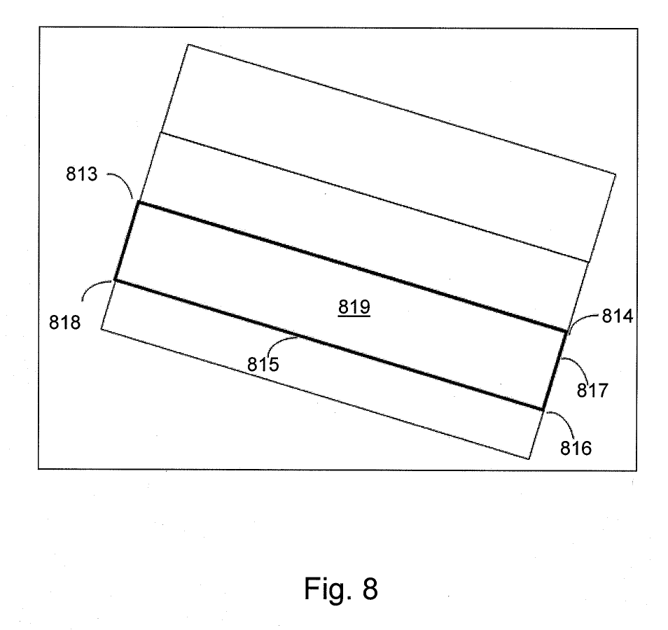

Referring to FIG. 8, in an embodiment, processor 117 can analyze and process the parameters to identify an available and useable area, such as roof area 819, for installing a solar energy system. The roof area 819 can be defined by points 813, 814, 816, 818, and lines 815 and 817, which the processor 117 records to calculate the area. An effectively useable area in which to place the solar energy system can then be calculated, so that solar panels on the solar energy system can be set to an optimal angle. An optimal position of the solar energy system within the useable area may also be determined by assessing angle and east-west orientation of the useable area. Based on analysis of the parameters, the processor 117 can determine adjustments to both tilt and alignment angles of the solar panels, so that the solar panels can receive optimal irradiation by the sun. The adjusted tilt and alignment angles oftentimes differ from the pitch and axis of the roof. As a result, the solar panels can be arranged in a “fish scale” type pattern in which the solar panels can be tilted on either one or both axes from the roof pitch. In addition, the axes of the solar panels can be rotated relative to the axis of the roof. Gaps may be also be added between solar panels to minimize mutual shading of panels as a result of axis and pitch adjustments. The processor 117 can utilize the processed parameters to generate a graphical representation of the solar energy system in the useable area of the location, and can display the graphical representation on the user interface in real-time. The graphical representation can be two-dimensional or three-dimensional.

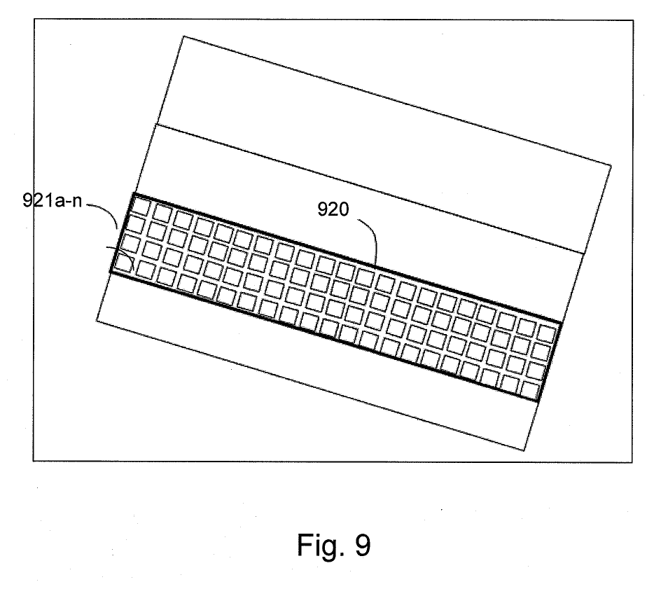

Referring to FIG. 9, in an embodiment, processor 117 can superimpose images of multiple solar panels 921 onto an image of a useable area 920 of a rooftop, and can present the superimposed images on web browser 132 on display 134 of user platform 130. The placement of the solar panels 921 can be modified to accommodate features such as chimneys, skylights, vents, or cost expectations. Once the placement, angle, and orientation of the solar panels 921 are fixed, processor 117 can generate an itemized bill of materials (BOM) and/or a price quote for the solar energy system. Processor 117 can then present the BOM and price quote on display 134.

In addition to configuring solar energy systems and providing BOMs and price quotes, the system 101 can also provide a standard e-commerce interface, for instance, an electronic shopping cart, displayed on web browser 132 to allow users to select a particular solar energy system configuration for purchase. Once selected for purchase, processor 117 can retrieve any applicable tax credits, incentives, and rebates from data store 111 or server 120, and can adjust the price quote accordingly.

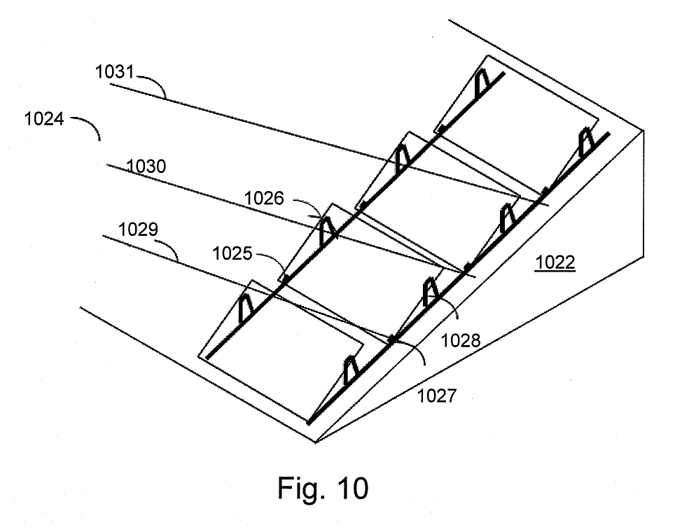

Referring to FIG. 10, exemplary hardware for configuring an embodiment of the present invention is illustrated. In analyzing and processing parameters associated with roof surface 1024, processor 117 may determine that the roof pitch 1022 may not be high enough to optimize the solar panels. Brackets 1025, 1026, 1027, and 1028 can be utilized to adapt the solar panels from the existing roof pitch 1022 to the desired angle of the local latitude. If processor 117 determines that the east-west orientation is not correct, then the solar panels can be repositioned to the correct location, represented by lines 1029, 1030, and 1031. This repositioning may also require that the panel mounting brackets 1025, 1026, 1027, and 1028 be adjusted. When both the angle and orientation of the solar panels are accommodated, all four of the mounting brackets can be at different heights.

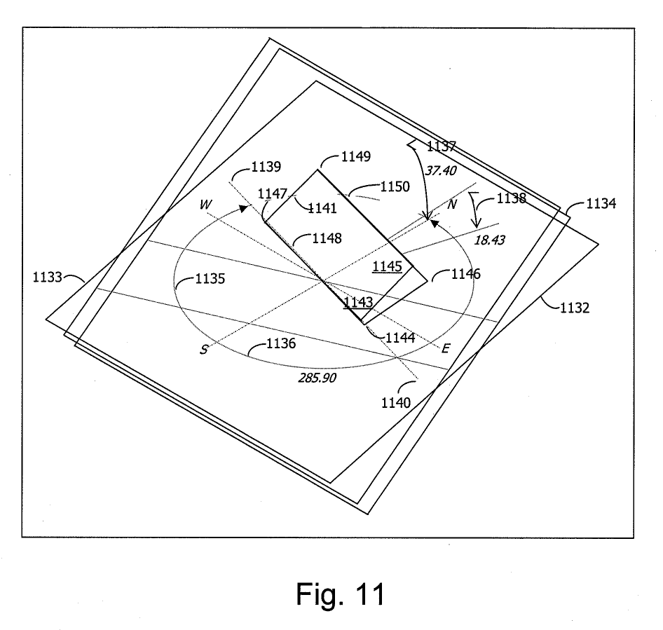

FIG. 11 illustrates an exemplary layout and associated data. The system offers three surface planes 1132, 1133, and 1134. Surface plane 1132 is the pitch 1138 of the roof rotated about line 1139-1140 at the azimuth angle 1135, in this example +105.9°. A positive azimuth 1135 in the northern hemisphere is west of south. A negative azimuth 1136 in the northern hemisphere is east of south. Plane 1134 is a plane at the angle of the local latitude rotated about the east-west axis. Plane 1133 is a plane parallel and offset to plane 1134, the plane at the local latitude 1137. The offset of plane 1133 represents the distance the solar panel is positioned from the roof at the lowest point. This known data of roof pitch 1138, azimuth angle 1135 or 1136, local latitude 1137, and the available solar panel sizes can drive a design table that can determine the height of the four mounting brackets 1025, 1026, 1027, and 1028. The height of bracket 1025 is represented by the distance between points 1147 and 1148. The height of the other three brackets can be determined in the same manner. The system according to the current invention provides a default layout of the solar panels on the roof image, taking into account the available area, panel options, and aesthetics such as aspect ratios. For example, if there is a large delta between the roof pitch 1138 and the optimal angle of the local latitude 1137, the processor 117 can choose a landscape aspect angle because it can typically be more aesthetically pleasing than a portrait aspect ratio. The processor 117 can provide preference to the slope angle 1137 (latitude) over the azimuth angle 1135 or 1136 in the evaluation of aesthetics, because variations in azimuth angles 1135 or 1136 are less important than yearly energy production.

In an embodiment, the present invention can be configured as a web-based application. Referring to FIG. 2, in operation, an exemplary web-based application having a browser interface 200 (or other graphical user interface) can be launched on user platform 130 by a user. The user can enter an address 201, of a location slated for installation of a solar energy system, in the address field 203 of the browser interface 200. The user can then select search button 202 to cause one or more images of the location (i.e., rooftop 205) to appear in the browser 200. In response to the user selection, the processor 117 can retrieve, for instance, five images (shown in FIGS. 2-6) of perspective views of the rooftop 205 from data store 111, or from a mapping service on server 120. The processor 117 can then display the images on the user interface 200. The displayed images provide a visual template with which the user can interact.

Specifically, the user can provide input data by utilizing the browser 200 (or other cursor controlled interface) to draw points, lines, and geometric shapes over the displayed images in order to create a computer model of the images. The user may also assist the processor 117 to identify points, lines, and geometric shapes, and to correlate them in different views to generate coordinates. For example, the user can utilize the web browser and cursor to select a point seen on one of the images to identify the point to the computer. Similarly, the user can identify the same point on the other images, or can identify a section of rooftop 205. This correlates the various perspective images with one another, and allows the processor 117 to correct the points in different views. The processor 117 can receive this input data, and can overlay the input data onto the displayed image in real time. The processor 117 may also utilize an automated edge detection feature to display various suggested points and lines to the user. The user may then select or modify the suggestions.

The processor 117 can process the images and input data to determine parameters associated with the rooftop 205. The parameters can include area of the rooftop 205, latitude, longitude, orientation, and three-dimensional coordinates. To determine three-dimensional coordinates from the two-dimensional images, the processor 117 can utilize the input data from the user identifying a particular point in at least two of the images having different viewing angles, and can then calculate the three-dimensional coordinates of the particular point. If the input data identifies the particular point in more than two of the images, a best-fit algorithm may be used by the processor 117 to determine more precise three-dimensional coordinates.

Once the parameters are determined, the processor 117 can evaluate parameters to identify a useable area on the rooftop for placement of the solar energy system. The processor 117 can then generate a three-dimensional graphical representation of the solar energy system in the useable area of the rooftop 205. The processor 117 can then display the graphical representation on the browser 200 in real-time.

The processor 117 can also generate and display a bill of materials and/or a price quote for the solar energy system displayed in the graphical representation. Any available incentives, tax credits, and subsidies may be retrieved by processor 117 from data store 111 or server 120 and applied to offset the price quote. The user may then select the solar energy system presented in the graphical representation for purchase, by clicking on the associated HTML link. Alternatively, the user may select the solar energy system for purchase by adding it to an electronic shopping cart. The processor 117 can be configured to receive the user's selection, and to complete the transaction by, for instance, crediting the user's account or requesting the user's credit card information.

The present invention may be utilized to configure solar energy systems on any structure or location. User-provided variables may include roof pitch and size preference of the solar energy systems, e.g., 2 kw, 2.5 kw 3 kw, 3.5 kw. In an embodiment, the present invention also provides for configuring all the available space on a structure with solar energy systems. For example, a user could be informed that he could place 4.3 kw of solar panel on a particular structure or site. The user could also be provided with a price quote and a bill of materials (BOM).

In an embodiment, the present invention may also provide solar system sizing tools that allow a user to determine a preferred system size. Typically, for residential installations that size can range from about 2 kw to about 6 kw. Sometimes, the size of the system can be limited by the available space for the installation or by economics. Multi-tier and time of use (TOU) rate structures, where present, can impact the optimization of both array size and orientation of solar panels. For example, if an energy consumer has a multi-tier rate structure and a load profile such as summer air-conditioning loads that require the use of expensive tier 4 and 5 electrical power, the consumer may be able to secure a 70 percent cost saving while sizing a system that only provides 50 percent of their kWh usage.

In an embodiment, the present invention can provide users with the ability to qualify prospective solar energy system clients and sites. Specifically, by using a subset of targeted leads, users can make additional assessments to improve the quality of the prospective leads. For example, a particular location can be evaluated to determine that a potential client has a good location, adequate area available at an appropriate angle and orientation, and that there are not trees or other structures that would shade the solar panels.

In an embodiment, a solar energy contractor can utilize the present invention to qualify clients and sites, and to place or layout a preferred solar energy system. Advantageously, a detailed BOM and price estimate for the installation can be provided in real-time. This feature can provide for an iterative process allowing multiple “what if” scenarios to be evaluated in real time.

In another embodiment, the present invention can be utilized directly by a consumer to configure a solar energy system for a home project, receive a BOM and quote in real-time, and to optionally select the system for purchase via an electronic shopping cart.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system for configuring solar energy systems comprising:
at least one processor; and
a memory coupled to the at least one processor, the memory storing instructions to cause the at least one processor to:
search one or more data sources for information;
store the information in a data store;
receive one or more images associated with a location to receive a solar energy system;
display the one or more images in real-time on a user interface on a display;
receive input data from a user interacting with the user interface;
process the information, images, and input data to determine parameters associated with the location; and
identify a useable area in the location for placement of the solar energy system based on the parameters.

2. The system of claim 1, wherein the processor is further configured to overlay the input data on the displayed image.

3. The system of claim 1, wherein the processor is further configured to determine position of the solar energy system within the useable area based on angle and east-west orientation of the useable area.

4. The system of claim 1, wherein the processor is further configured to generate a graphical representation of the solar energy system in the useable area of the location, and to display the graphical representation on the user interface in real-time.

5. The system of claim 1, wherein the processor is further configured to generate and present on the display at least one of a bill of materials or price quote for the solar energy system.

6. The system of claim 1, wherein the processor is further configured to receive from the user a selection of the solar energy system for purchase.

7. The system of claim 1, wherein the processor utilizes at least one of an application programming interface (API) and screen scraper to search the one or more data sources for the information.

8. The system of claim 1, wherein the data sources include at least one of websites and databases.

9. The system of claim 1, wherein the information includes at least one of product data, services, incentives, rate structures, and regulations pertaining to solar energy systems.

10. The system of claim 1, wherein the processor receives the one or more images in real-time from remote servers.

11. The system of claim 1, wherein the processor receives the one or more images from the data store.

12. The system of claim 1, wherein the one or more images are any of map images, terrain images, or topology images.

13. The system of claim 1, wherein the location is a roof of a building.

14. The system of claim 1, wherein the processor displays the one or more images in real-time on the user interface in response to a request by the user for the one or more images.

15. The system of claim 14, wherein the request by the user includes at least one of an address or latitude and longitude coordinates of the location.

16. The system of claim 1, wherein the user interface is a web browser.

17. The system of claim 1, wherein the display is on any of a handheld communication device, laptop, and desktop computer.

18. The system of claim 1, wherein the input data includes at least one of points, lines, geometric shapes, height measures, and length measures associated with the displayed one or more images.

19. The system of claim 1, wherein the input data identifies particular points, lines, or geometric shapes in each of the displayed images.

20. The system of claim 1, wherein the parameters include at least one of location area, three-dimensional coordinates, latitude, longitude, azimuth angle, orientation, alignment, pitch, ambient temperature of the location, indications of shading obstructions in the useable area, and size of the solar energy system that can fit in the useable area.

21. A method of configuring solar energy systems, the method comprising:
searching one or more data sources for information;
storing the information in a data store;
receiving one or more images associated with a location to receive a solar energy system;
displaying the one or more images in real-time on a user interface on a display;
receiving input data from a user interacting with the user interface;
processing the information, images, and input data to determine parameters associated with the location; and
identifying a useable area in the location for placement of the solar energy system based on the parameters.

22. The method set forth in claim 21, further comprising overlaying the input data on the displayed image.

23. The method set forth in claim 21, further comprising determining position of the solar energy system within the useable area based on angle and east-west orientation of the useable area.

24. The method set forth in claim 21, further comprising generating a graphical representation of the solar energy system in the useable area of the location, and displaying the graphical representation on the user interface in real-time.

25. The method set forth in claim 21, further comprising displaying at least one of a bill of materials or price quote for the solar energy system.

26. The method set forth in claim 21, further comprising receiving from the user a selection of the solar energy system for purchase.

27. The method set forth in claim 21, wherein receiving the one or more images includes requesting the one or more images in real-time from remote servers.

28. The method set forth in claim 21, wherein receiving the one or more images includes retrieving the one or more images from the data store.

29. The method set forth in claim 21, wherein displaying the one or more images in real-time is in response to a request by the user.

30. The method set forth in claim 21, wherein processing includes identifying identical points, lines, or geometric shapes in each of the displayed images.

31. A computer readable medium having stored therein program instructions that are executable to perform:
searching one or more data sources for information;
storing the information in a data store;
receiving one or more images associated with a location to receive a solar energy system;
displaying the one or more images in real-time on a user interface on a display;
receiving input data from a user interacting with the user interface;
processing the information, images, and input data to determine parameters associated with the location; and
identifying a useable area in the location for placement of the solar energy system based on the parameters.

32. The computer readable medium of claim 31, further comprising program instructions for overlaying the input data on the displayed image.

33. The computer readable medium of claim 31, further comprising program instructions for determining position of the solar energy system within the useable area based on angle and east-west orientation of the useable area.

34. The computer readable medium of claim 31, further comprising program instructions for generating a graphical representation of the solar energy system in the useable area of the location, and displaying the graphical representation on the user interface in real-time.

35. The computer readable medium of claim 31, further comprising program instructions for displaying at least one of a bill of materials or price quote for the solar energy system.

36. The computer readable medium of claim 31, further comprising program instructions for receiving from the user a selection of the solar energy system for purchase.

37. The computer readable medium of claim 31, further comprising program instructions for requesting the one or more images in real-time from remote servers.

38. The computer readable medium of claim 31, further comprising program instructions for retrieving the one or more images from the data store.

39. The computer readable medium of claim 31, further comprising program instructions for displaying the one or more images in real-time in response to a request by the user.

40. The computer readable medium of claim 31, further comprising program instructions for identifying identical points, lines, or geometric shapes in each of the displayed images.
